(19) United States
(12) Patent Application Publication
(10) Pub. No.: US 2007/0083607 A1
(43) Pub. Date: Apr. 12, 2007

(54) Method of operating a computer network

(76) Inventors: Simon G. Thompson, Ipswich (GB); Nick Giles, Ipswich (GB); Hamid Gharib, Ipswich (GB); Yang Li, Ipswich (GB); Lyndon C. H. Lee, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/573,267

(22) PCT Filed: Sep. 30, 2004
(86) PCT No.: PCT/GB04/04177

§ 371 Date: Mar. 23, 2006

(30) Foreign Application Priority Data
Sep. 30, 2003 (GB) 0322871.5

(51) Int. Cl. G06F 15/16

(52) U.S. Cl. 709/217

(57) ABSTRACT

A method of invoking, from a device connected to a computer network, an electronic service, from amongst a plurality of such services, available from the network. The method comprises: receiving an electronic signal representative of a request for an electronic service, the service request being expressed in a first ontology; forming a group of mappings each of which specifies a method for mapping from the first ontology to another ontology; using the formed group of mappings to compare the received service request with descriptions of services available on the network expressed in the first ontology or any of the ontologies to which a mapping is available from the first ontology in the formed group of mappings; selecting one of the electronic services available on the network based on the result of the comparison; and transmitting an electronic signal to invoke the selected service.

### FIELD OF THE INVENTION

The present invention relates to a method of operating a network and in particular to a method and apparatus for searching for one or more electronic services offered over a computer network.

### BACKGROUND OF THE INVENTION

In addition to storing data for access by other devices, server computers connected to the Internet and/or other computer networks increasingly offer electronic services to other devices (e.g. user terminals) connected to the corresponding network. Such electronic services typically require data to be input from a requesting device in a particular format; the server computer then processes the input data and returns output data to the requesting device again in a particular format. At present most such services must be located by a human user who compares a natural language description of each of the offered services to decide which is or are the most appropriate for selection, and then ensures that data is provided to the selected service(s) in the correct format and ensures that the output data is correctly interpreted.

There is a general drive to try to automate some of the above procedures. The first problem encountered when attempting to automate this procedure is that the description of the service tends to be written in a natural language such as English or German which is not machine understandable. In recent years, a number of technologies have been developed which are relevant to this problem.

For example, a service description language known as Web Services Description Language (WSDL) has been defined. This language is described in a technical report submission to the World Wide Web Consortium and may be viewed from their web-site. WSDL enables a service to be described in terms of the calls, and associated parameters, which may be made to the service to invoke it, together with the data type or types of the value or values that the service returns.

More sophisticated service description languages have also been developed which allow services to be described in terms of their behaviours and the result(s) of their invocation. In the ADEPT project a service description language called ASDL was developed which had these characteristics. More recently, the DAML-S coalition has developed a service description language of this sort which is widely used in academic research and is beginning to be used more widely as well. DAML-S stands for DAML-based web Service ontology, DAML stands for DARPA Agent Mark-up Language, with DARPA standing for Defence Advanced Research Projects Agency. At the date of filing this application, details of this ontology can be found at the Uniform Resource Locator (URL) http://www.daml.org/services/

In the context of the present invention, the term ontology is used to refer to an explicit formal specification of a conceptualisation, where the term “formal” here means some logical formalism. A conceptualisation includes concepts which may denote real or abstract entities such as Person, Animal, Dog, Mood, Condition, etc. A conceptualisation may also include structures such as <concept “Person” has attributes such as “name”, “gender”, “date of birth”, etc.> and relationships such as <concept “Person” is a sub-category of concept “Animal”>, <concept “Person” has concept “Mood”>, etc. An ontology may also include one or more axioms, such as <concept “Person” and concept “Dog” are disjoint>, <concept “Mood” cannot apply to concept “Condition”>, etc.

An ontology can thus be described as a set of terms defined in the form of a constrained cyclic graph of relationships, or an acyclic graph such as a hierarchy. These graphs of relationships between terms can be thought of basically as sets of data types and the relationships between those types and are used as the basis of software which interprets the meaning of the specified terms. In the present document two types of ontology are referred to, operational ontology and service ontology. The operational ontology is the ontology which the service uses when it is invoked. This will therefore cover things such as the expression of calls to the service or operations provided by the service as well as the expression of messages or output results from the service or operations provided by the service. The service ontology covers the set of terms which that the respective service uses to describe itself.

There is, however, a problem with both of the above-referred-to service description language/ontology proposals which is that they are not compatible with one another, each assuming that every service available in a network will be described in one or other of these forms.

A more robust approach therefore is to assume that there may well be a number of different machine-understandable service description languages/ontologies available and that different services will choose different ontologies in which to present their service description. In such an environment, it is possible that an application seeking a particular service might fail to correctly identify an appropriate service merely because it has generated a service request specifying the nature of the service which it requires in a different service ontology to that in which the available service has presented its service description.

In such a scenario, a mechanism is required for enabling services described in different ontologies to be compared with one another. The paper “LARKS: Dynamic Matchmaking Among Heterogeneous Software Agents in Cyberspace” published in Autonomous Agents and Multi-Agent Systems, Volume 5, No. 2, 173203, June, 2002, by Katia Sycara et al. describes such a mechanism in which a “partial global terminology” is dynamically built and maintained based on received concept definitions. Thus in this case, a global ontology is developed and anything expressed in an ontology which is mappable to the global ontology can therefore be “understood” by re-expressing it in the global ontology.

The present invention seeks to provide an alternative mechanism for coping with multiple ontologies which is flexible and suitable for locating electronic services offered over a computer network.

### SUMMARY OF THE INVENTION

According to a first aspect of the present invention, there is provided a method of performing a requested service on behalf of a requesting user, the method comprising:
receiving at a user device accessible to the user a signal representative of a description of the requested service expressed in a first service description ontology together with either input data expressed in a first operational ontology or an indication that input data will subsequently be provided in the first operational ontology from a specified source if a suitable service is located;
performing a search for a suitable service through a plurality of services accessible to the user device, each accessible service having an associated service description expressed in a corresponding service description ontology and having an associated operational ontology, the searching being carried out by comparing the service description of each accessible service with the service description of the requested service, the comparison step including using, or forming and using, service description ontology mappings where necessary and, in respect of at least the or each, if any, of the accessible service having a service description matching the requested service, determining if its operational ontology is compatible with the first operational ontology and if so, determining that the or each such accessible service having a matching service description and a compatible operational ontology is a suitable service;
invoking the suitable service or one of the suitable services, if at least one has been found, including translating if necessary the input data from the first operational ontology into the operational ontology of the suitable service and sending the, possibly translated, input data to the suitable service or informing it of from where to obtain the input data; and
translating, if necessary, the output data from the suitable service and presenting the, possibly translated, output data to the user.

Note that the “user” referred to above could be a human user but equally the user could be a computer device or an autonomous agent coordinating the carrying out of a larger composite task on behalf of a human or computer user, etc.

The identification of the first service description ontology and the first operational ontology can be made explicitly within the originally received signal, or alternatively, it could be done implicitly, e.g. because the user in question has a default set of ontologies which it uses, or because the user terminal is able to determine from the request what the ontologies used are, or because the signal includes reference to one or two ontology identifiers which are known to the user terminal, etc.

The plurality of services accessible to the user device could be restricted to those stored locally on the user terminal, or to those stored on the user terminal and/or any stored on an intranet to which the user terminal is connected, however, it is preferable if the user terminal can search through services located on any device to which the user terminal can gain access, including any device accessible via the Internet.

The operational ontology of a service will be deemed compatible with the first operational ontology if the ontologies are the same (i.e. the operational ontology of the service is the first operational ontology) or if the user terminal has access to a mapping between the operational ontology of the service and the first operational ontology. Note that generally a mapping will provide a two-way mapping allowing translations to go in either direction, however, it is possible that in some cases there could be a mapping which is only valid in one direction (e.g. because a first ontology includes concepts which simply don't exist in a second ontology, in such a case a complete mapping may exist from the second ontology to the first with only a partial mapping from the first to the second) in such cases the method preferably selects services with a complete mapping in preference to those for which there is only a partial mapping, but will attempt to use services where only a partial mapping exits if necessary.

It is anticipated that the user will typically require the output data to be expressed in the same operational ontology as the input data (i.e. in the first operational ontology). However, in some cases the desired output operational ontology may be different to the input ontology. In such cases, the method also needs to check for compatibility between the output ontology of the accessible service and the desired output ontology for expressing the output data to the user.

The method of the first aspect of the present invention enables authors to create services which explicitly include a service description written in one ontology (which may be well suited for writing service descriptions) but to use a separate operational ontology (or ontologies—e.g. separate input data and output data ontologies) which may be better suited for expressing input and output data of the service and yet to enable other computers to correctly identify and employ these services in many contexts not necessarily envisaged by the author of the service at the time of creating the service.

According to a second aspect of the present invention, there is provided a user device as set out in claim 6.

According to a third aspect of the present invention, there is provided a method of invoking, from a device connected to a computer network, an electronic service, from amongst a plurality of such services, available from the network, the method comprising:
receiving an electronic signal representative of a request for an electronic service, the service request being expressed in a first ontology;
forming a group of mappings each of which specifies a method for mapping from the first ontology to another ontology;
using the formed group of mappings to compare the received service request with descriptions of services available on the network expressed in the first ontology or any of the ontologies to which a mapping is available from the first ontology in the formed group of mappings;
selecting one of the electronic services available on the network based on the result of the comparison; and
transmitting an electronic signal to invoke the selected service.

Preferably, the method additionally includes comparing the ontology in which the input data is intended to be supplied to an electronic service once located, and the desired ontology in which the resulting output data is to be output by the service, with the operational ontology of the selected service, and if these are different, determining if a mapping is available on the network for mapping between these ontologies and if not, then trying to find a new service to select.

In a preferred embodiment, the method includes compiling a mapping database of mappings from one ontology to another and building the mapping database according to the following method:
populating the mapping database with a plurality of direct mappings from one ontology to another; and subsequently
upon receiving a service request expressed in a first ontology, generating a first set of mappings which map from said first ontology to a specified target ontology by selecting appropriate mappings from the mapping database;
forming a second set of mappings which map from any of the target ontologies of the mappings in the first set to a specified secondary target ontology which is different from the first ontology and all of the target ontologies of the mappings in the first set, by selecting any such mappings from the mappings database; and
storing in the mappings database an indication of a new mapping from said first ontology to the secondary target ontology corresponding to one of the mappings in the second set, together with a reference to each of the corresponding mappings in the first and second sets required to make the mapping from the first ontology to the secondary target ontology.

The above database building method may be used in a number of different ways. For example, it could be used in a completely exhaustive manner whereby the process is repeated continually until finally an iteration is reached, in respect of a given first ontology, for which no mappings exist in the mapping database which satisfy the requirements for entry into the second set. Indeed, a variant on the building method could be used which goes through this process exhaustively in respect of each possible “first” ontology to thus build up a complete set of all possible mappings between ontologies for which there is at least one direct mapping available in the database. This procedure could then be instigated every time a new direct mapping is added to the database to keep the database constantly as complete as possible.

Alternatively, fewer indirect mappings could be kept in the mapping database to provide for better scaling in the event of there being a very large number of different ontologies referred to in the mapping database, with various heuristics being used to determine when to stop adding further indirect mappings to the database. One such heuristic could be to initially generate only the first set of mappings and then to search for suitable services using only the ontologies available from this first set, and then to perform only a single iteration of the building method, in the event that no suitable services can be found, and to then search for services using any newly found ontologies before repeating the procedure again only if still no suitable services may be found, etc.

An alternative and particularly preferred heuristic is suitable for use in cases where two or more services are simultaneously required by a user for a particular purpose, and where the corresponding service requests are expressed in different ontologies. In such a case, the present inventor has found that it is particularly beneficial to perform the above described procedure until a mapping is found between the different ontologies in which the service requests are expressed and then to carry out searching for suitable services in all of the ontologies used in the mapping between the different ontologies.

According to a fourth aspect of the present invention, there is provided a method of operating a computer network comprising:
providing one or more groups of computer programs and associated data so as to provide one or more services to other users of the computer network,
storing in association with each such service a description of the respective service expressed in a respective ontology,
storing in association with each such service an indication of the respective ontology in which its corresponding service description is expressed, and
making both the service description and the indication of the ontology in which it is expressed available for viewing by potential users of each such respective service.

According to a fifth aspect of the present invention, there is provided apparatus for searching for and invoking an electronic service available from a computer network, the apparatus including:
receiving means for receiving an electronic signal representative of a request for an electronic service, the service request being expressed in a first ontology;
digital processing and storage means for forming a group of mappings each of which specifies a method for mapping from the first ontology to another ontology;
processing means for using the formed group of mappings to compare the received service request with descriptions of services available on the network expressed in the first ontology or any of the ontologies to which a mapping is available from the first ontology in the formed group of mappings;
processing means for selecting one of the electronic services available on the network based on the result of the comparison; and
transmission means for transmitting an electronic signal to invoke the selected service.

### BRIEF DESCRIPTION OF THE FIGURES

In order that the present invention may be better understood, embodiments thereof will now be described, by way of example only, with reference to the accompanying Figures in which:

FIG. 1 is an illustration of a general purpose computer system which may form the operating environment of embodiments of the present invention;

FIG. 2 is a system block diagram of the general purpose computer system of FIG. 1;

FIG. 3 is a block diagram of a network arrangement in which a video conference call is organised according to a method according to an embodiment of the present invention;

FIG. 4 is a flow chart illustrating the method of an embodiment of the present invention;

FIG. 5 is a flow chart of an “attempt to expand set of mappings” subroutine of the flow chart of FIG. 4; and

FIG. 6 is a flow chart of a “Check for operational ontology compatibility” sub-routine of the flow chart of FIG. 4.

### DETAILED DESCRIPTION

The first embodiment provides a tool by which a user can search for and invoke multiple services offered over a computer network to which the user terminal (on which the tool is running) is connected. In alternative embodiments, the tool is provided on a server to which multiple user terminals have access.

### Description of the User Terminal

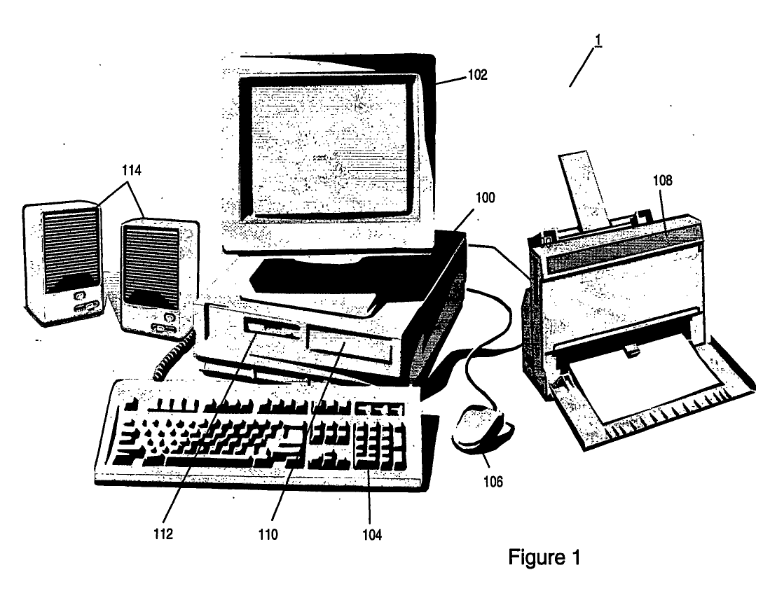

FIG. 1 illustrates a general purpose computer system which provides the operating environment of the first embodiment of the present invention. Later, the operation of the invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 1, a general purpose computer system 1 which forms the operating environment of the first embodiment of the invention, and which is generally known in the art, comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary embodiment only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

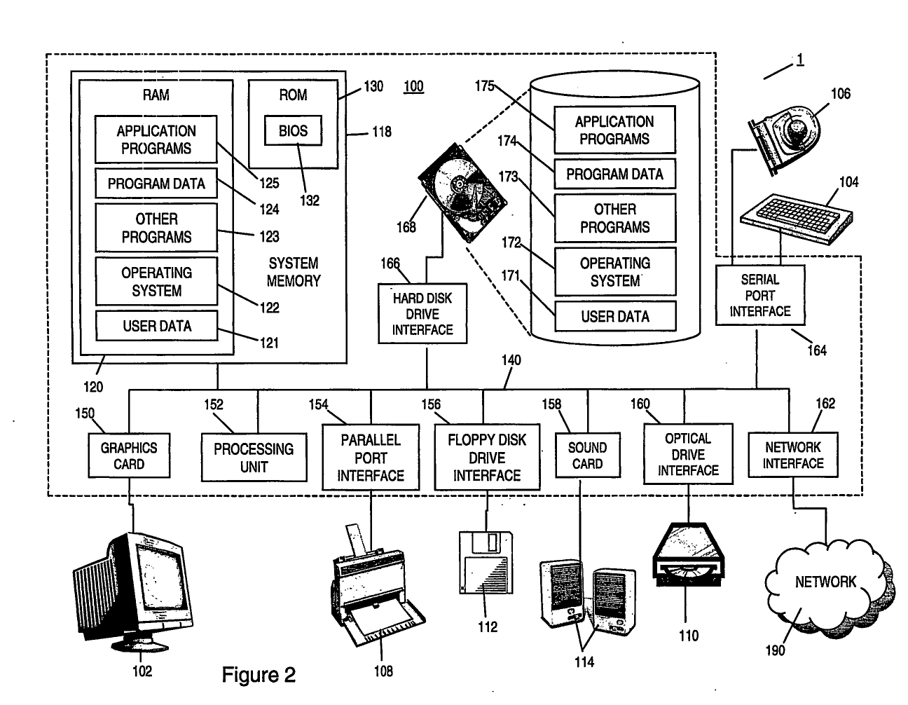

FIG. 2 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 2 illustrates one embodiment of the invention, it will be understood by the skilled man that other peripheral devices may be attached to the computer system, such as, for example, microphones, joysticks, game pads, scanners, digital cameras, or the like. In addition, with respect to the network interface 162, we have previously described how this is preferably a wireless LAN network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, as in the present embodiment, it should further be understood that the application programs, other programs, and other data which may be stored locally in the computer system may also be stored, either alternatively or additionally, on remote computers, and accessed by the computer system 1 by logical connections formed over the network 190.

### First Embodiment

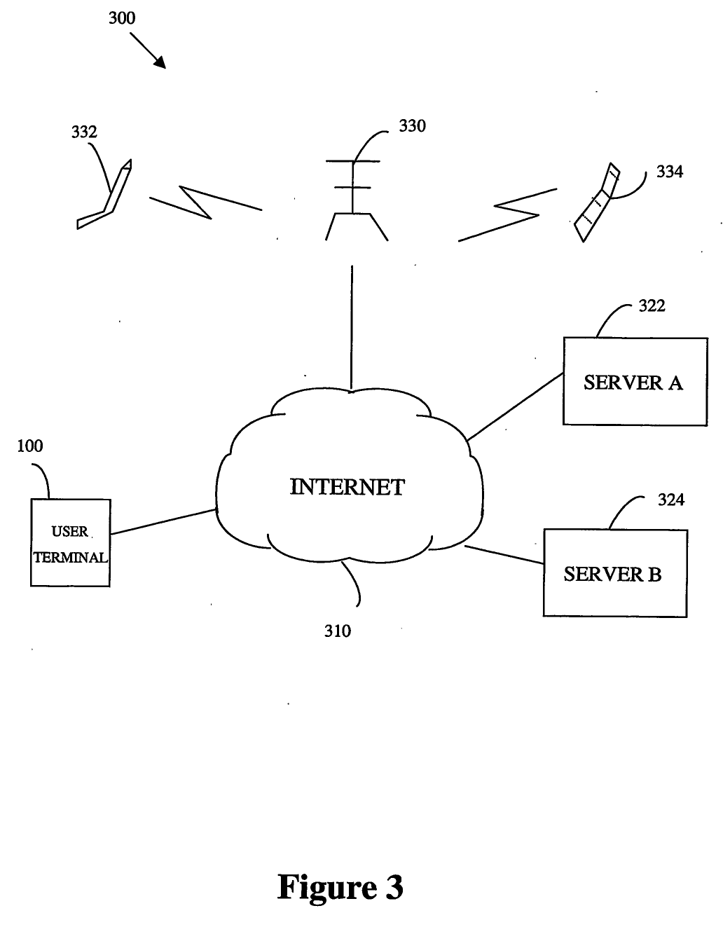

FIG. 3 shows an example arrangement of a computer network 300 in which an example of the method of the first embodiment is now described. A user at terminal 100 wishes to set up a video conference call with herself and two colleagues with mobile telephones 332 and 334 via the internet 310 and mobile network infrastructure 330. The video signals are generated in the MPG7 format by all of the devices 100, 332, 334 and need to be correctly displayed on both the computer monitor of the user terminal 100 (using a standard viewer application such as RealPlayer or Microsoft's Media Player) and the displays of the mobile telephones 332, 334. The user therefore wishes to search for two services, one to display MPG7 video on a personal computer and one to display MPG7 video signals on a mobile telephone.

The user therefore generates two service requests. The first service request is designated SR_{MPG7-PC} and is created in an ontology called PC-Display ontology. The second service request is designated SR_{MPG7-PHONE} and is created in an ontology called video-conference ontology. The software which in this embodiment runs on the user terminal 100 generates two sets of maps which map from one ontology to another. In particular, the software selects from a map store a first set of maps to map from the PC-Display ontology to any other ontology and a second set of maps to map from the video-conference ontology to any other ontology. In this case, the map store on the user terminal 100 stores the following maps:

M_{AUDIO}_{_{—}}_{VISUAL-VIDEO}_{_{—}}_{CONFERENCE} which maps between an audio_visual ontology and the video-conference ontology;

M_{AUDIO}_{_{—}}_{VISUAL-COMPRESSED}_{_{—}}_{VIDEO} which maps between the audiovisual ontology and a compressed_video ontology;

M_{AUDIO}_{_{—}}_{VISUAL-RESTRICTED}_{_{—}}_{AUDIO} which maps between the audio_visual ontology and a restricted_audio ontology;

M_{PC}_{_{—}}_{DISPLAY-PC}_{_{—}}_{PLAYERS} which maps between the PC-Display ontology and a PC-Players ontology;

M_{PC}_{_{—}}_{DISPLAY-DEVICE}_{_{—}}_{INDEPENDENT} which maps between the PC-Display ontology and a device-independent ontology;

M_{VIDEO}_{_{—}}_{CONFERENCE-DATA}_{_{—}}_{TRANSMISSION} which maps between the video-conference ontology and a Data-Transmission ontology;

M_{COMPRESSED}_{_{—}}_{VIDEO-DISPLAY}_{_{—}}_{DEVICES} which maps between the compressed_video ontology and a display_devices ontology; and

M_{DISPLAY}_{_{—}}_{DEVICES-PC}_{_{—}}_{PLAYERS} which maps between the display_devices ontology and the PC-Players ontology.

The first step of the method of this first embodiment is to select from the above set out maps a first set of maps which map to the PC-Display ontology and a second set of maps which map to the video-conference ontology. The first set is designated as S_{TARGET} and contains M_{PC}_{_{—}}_{DISPLAY-PC}_{_{—}}_{PLAYERS} and M_{PC}_{_{—}}_{DISPLAY-DEVICE}_{_{—}}_{INDEPENDENT} and the second set is called S_{SOURCE} and contains M_{AUDIO}_{_{—}}_{VISUAL-VIDEO}_{_{—}}_{CONFERENCE} and M_{VIDEO}_{_{—}}_{CONFERENCE-DATA}_{_{—}}_{TRANSMISSION}.

The aim of the first part of the method of the present embodiment is to try to find a series of maps which enable the ontology of one of the requests to be translated into the ontology of the second request, and then to translate both requests into all of the intermediate ontologies and then to search for the desired services in all of those intermediate ontologies. In the second part of the method, a similar procedure is used to try to find a map or series of maps for translating between the operational ontology of any suitable service found during the first part of the method and the operational ontology of the user terminal. The term operational ontology is used to refer to the format of input and output data required by a particular service or device, etc.

Thus having selected the above mentioned maps to include in the source and target sets, the method checks to see if they include either a direct map between the source and target ontologies or if there are maps to a common intermediate ontology. If so, this first part of the method ends and the service requests are translated into both the source and target ontologies as well as any intermediate ontologies and then a search for a suitable service is instigated in all of the various ontologies. However, in the present case there is no direct or indirect mapping available and so the method continues by selecting one of the source and target sets for expansion. In the present embodiment the set with the least number of members is selected for expansion with the source set being chosen by default if they have the same number of members as in this case. The S_{SOURCE} is selected for expansion. Expansion is performed by looking for any maps which map from one of the ontologies, mapped to by a map in the set to be expanded, to an ontology which is not mapped to by a map in the set to be expanded. Thus in the present case, the two maps M_{AUDIO}_{_{—}}_{VISUAL-COMPRESSED}_{_{—}}_{VIDEO} and M_{AUDIO}_{_{—}}_{VISUAL-RESTRICTED}_{_{—}}_{AUDIO} are selected and then used to form two new maps, namely M_{VIDEO}_{_{—}}_{CONFEFENCE-COMPRESSED}_{_{—}}_{VIDEO} and M_{VIDEO}_{_{—}}_{CONFERENCE-RESTRICTED}_{_{—}}_{AUDIO} which are then stored in the map store. These two new maps are composite maps in that they simply refer back to the underlying direct maps which can then be used in turn to perform the actual mapping. At this stage, it is checked again to see if there is now an intermediate ontology through which a route to translate between the source and target ontologies can be found. However, in the present case there is not so the set is further expanded.

After this next expansion the map M_{COMPRESSED}_{_{—}}_{VIDEO-DISPLAY}_{_{—}}_{DEVICES} is selected and used to form a new map M_{VIDEO}_{_{—}}_{CONFERENCE-DISPLAY}_{_{—}}_{DEVICES}. Still no through route is available from the source and target sets so the source set is expanded again. This time the map M_{DISPLAY}_{_{—}}_{DEVICES-PC}_{_{—}}_{PLAYERS} is selected and the new map M_{VIDEO}_{_{—}}_{CONFERENCE-PC}_{_{—}}_{PLAYERS} is formed and added to the expanded S_{SOURCE} set. At this point, the ontology PC-Players can be used as an intermediate ontology to translate across from the source to the target ontologies using the map M_{PC}_{_{—}}_{DISPLAY-PC}_{_{—}}_{PLAYERS} from the target set and the newly formed map M_{VIDEO}_{_{—}}_{CONFERENCE-PC}_{_{—}}_{PLAYERS} The first part of the process therefore ends at this point and a series of search requests are sent via the internet 310 to server A 322 which has a service directory. A suitable service residing on server B 324 is located in this way and the method proceeds to the second major part which is to try to find a translation from the operational ontology in which the user terminal 100 will generate data to be processed by the server B 324 and expect data to be returned to it, and the operational ontology of the service provided by server B 324. Note that if the method does not manage to find a route for translating from the source to the target ontology, the service requests are simply translated into all of the ontologies available from the maps stored in the source and target sets of maps.

To try to find a translation from one operational ontology to the other (if necessary), the method proceeds exactly as before, thus two sets of maps are formed, a source set and a target set, and it is looked to see if one or two of these can be used to form the operational ontology translation. If not, one of the sets is selected and then expanded until a translation is found. If no translation can be found an alternative service is looked for from the service directory on server A322. Finally, the service is invoked and as a result the video conference call takes place.

### Second Embodiment

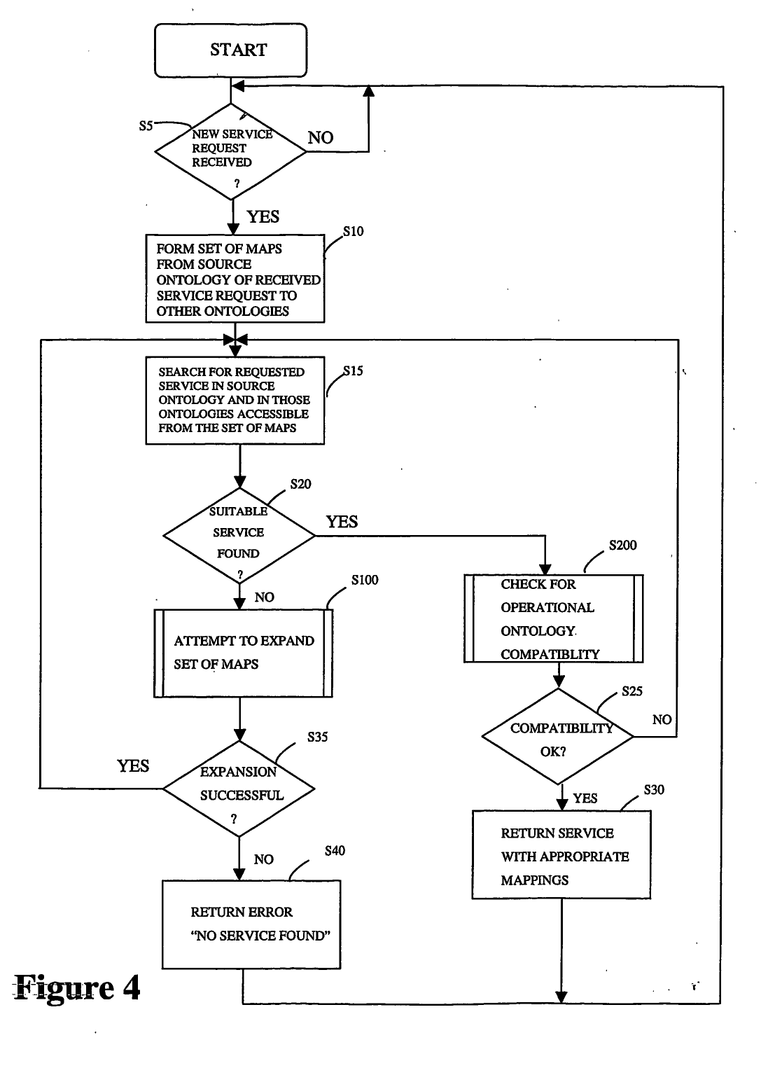

A second embodiment of the present invention is now described with reference to FIGS. 4, 5 and 6. In this embodiment, the method is carried out by a server computer to which lots of user terminals have access. The server computer maintains a large store of ontology maps. According to this method, at step S5 the server waits for a new service request to be received. As soon as one is received the method proceeds to step S10 in which the ontology in which the service request has been formulated (hereinafter referred to as the source ontology) is determined and then a set of maps from the source ontology to any other ontology is formed by selecting any such maps from the server's general store of ontology maps.

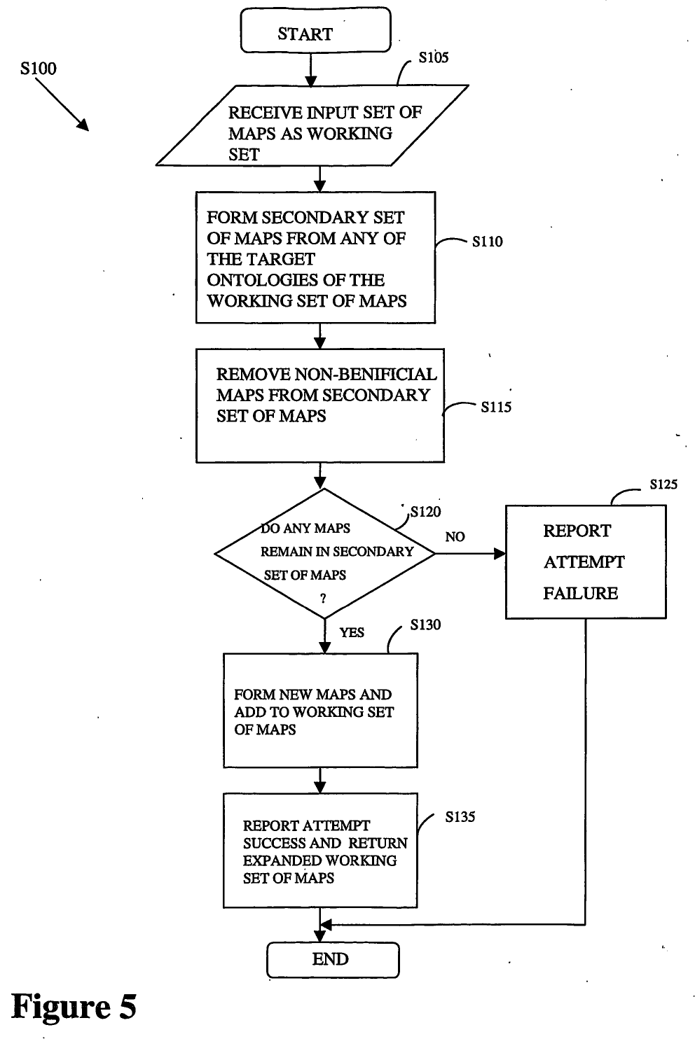

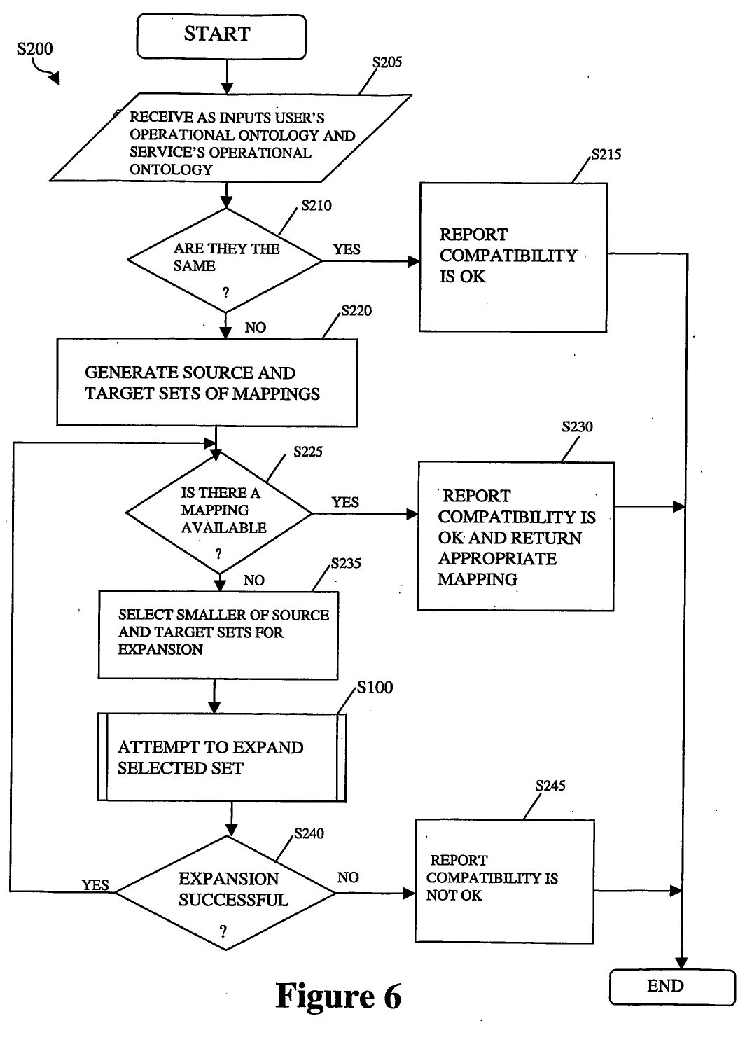

Having formed this set of ontology maps, the method proceeds to step S15 where a search is carried out using the service request translated into all of the ontologies available from the set of maps as well as in the original source ontology, by contacting one or more suitable directories. In step S20 it is then determined whether or not a service which matches the service request has been found. If such a service has been found the method proceeds to subroutine S200 (which is illustrated in full in FIG. 6). If no such service has been found then the method proceeds to subroutine S100 in which an attempt is made to expand the set of maps. The details of this sub-routine are explained in greater detail below with reference to FIG. 5. Upon completion of sub-routine S100 the method proceeds to step S35 in which it is determined if the expansion attempt was successful. If the expansion was successful the flow in the method reverts back to step S15 and a new search is carried out using the new ontologies available as a result of the expansion of the set of ontology maps. If the expansion is not successful, flow passes to step S40 in which the server returns a failure message back to the user who sent the request originally and then the method returns to step S5 to await for a new service request.

If at step S20 a service which matches the service request is found, then at subroutine S200 the operational ontology of the found service is compared with the operational ontology requested by the user in the original service request. If the sub-routine S200 detects that the operational ontology of the service is the same as that requested by the user, the output of the subroutine is that the compatibility of the service is OK, similarly if they are different but the subroutine is able to find a translation between the two different ontologies, then the output of the subroutine is that the compatibility is OK and also providing the necessary ontology map. If the subroutine is unable to find a suitable translation the output of the subroutine is a notification that the compatibility is not OK.

Upon completion of subroutine S200, the method proceeds to step S25 where it is determined if the subroutine has reported that the operational ontologies are compatible. If they are not, flow passes back to step S15 and a new service is looked for. If the compatibility is ok then the server returns to the user a message advising the user of the service and including a map for translating between the operational ontology of the service and the requested operational ontology provided by the user where necessary. After this the method returns to step S5 to wait for a new service request.

Referring now to FIG. 5, upon commencement of the expansion attempt subroutine, the method proceeds to step S105 in which the subroutine receives as an input a working set of ontology maps. The method then proceeds to step S110 in which a secondary set of ontology maps is formed by selecting any maps from the map store which map from any one of the ontologies mapped to by the maps in the working set of maps to any ontologies not currently mapped to by any of the maps in the working set. The method then proceeds to step S115 in which any non-beneficial maps are removed. Non-beneficial maps are maps which would be redundant if they were processed (e.g. if the working set has maps from A to B and A to C, and if maps from both B to D and C to D were added to the secondary set in step S110, then one of these would be redundant, as either one could be used to form a new map from A to D, and is therefore removed in step S115).

Upon completion of step S115 the method proceeds to step S120 in which it is determined if any maps remain in the secondary set. If there are not then the attempt to expand the working set is unsuccessful and the method proceeds to step S125 in which the subroutine reports back that the attempt to expand the set of maps has been unsuccessful and then the subroutine ends.

If at step S120 it is determined that there are some maps in the secondary set of maps, then the method proceeds to step S130 in which new composite maps are formed and stored in the map store by combining each of the maps in the secondary store with the corresponding map in the working set and then the or each newly formed map is added to the working set. The method then proceeds to step S135 in which reports that the attempt to expand the input set of maps has been successful and it returns the expanded working set of maps as its output. The subroutine then ends after completion of step S135.

Referring now to FIG. 6, upon commencement of subroutine S200, the method proceeds to step S205 in which the subroutine receives as inputs from the main method the operational ontology requested by the user in the user's original service request and the operational ontology of the service located in step S15 of the main method (see FIG. 3). The method then proceeds to step S210 in which it is determined if the two input ontologies are the same. If they are, the method proceeds to step S215 in which the subroutine reports that the operational ontologies are compatible and then the subroutine ends. If at step S210 it is determined that the ontologies are not the same, the method proceeds to step S220 in which source and target sets of maps are generated by selecting from the map store maps which map to or from (note these maps are all bi-directional) the requested operational ontology and the service's operational ontology respectively.

The method then proceeds to step S225 in which it is determined whether there is a map or pair of maps in either or both of the source and target sets of maps which could be used to map from the source ontology (i.e. the operational ontology requested by the user) to the target ontology (i.e. the operational ontology used by the located service). If it is determined that there is such a map or a pair of maps available then the method proceeds to step S230 in which the subroutine reports that the operational ontologies are compatible and returns the necessary map or maps for performing the mapping from the one ontology to the other, and then the subroutine ends.

If at step S225 it is determined there is not a map or pair of maps in the source and target sets of maps, then the method proceeds to step S235 in which the smaller of the source and target sets of maps is selected for expansion (with the source set being selected in the event that the sets of the same number of maps) and then the selected set is input to subroutine S100 which attempts to expand the input set of maps as has been described above. Upon completion of subroutine S100, the method proceeds to step S240 in which it is determined if the expansion attempt was successful. If so, then the method returns to step S225 in which it is determined whether there is a map or pair of maps available in the source and target sets which would enable a mapping between the ontologies.

If at step S240 it is determined that the expansion attempt has been unsuccessful, then the method proceeds to step S245 in which subroutine 200 reports that the ontologies are not compatible and then the subroutine ends.

1. A method of performing a requested service on behalf of a requesting user, the method comprising:
receiving at a user device accessible to the user a signal representative of a description of the requested service expressed in a first service description ontology together with either input data expressed in a first operational ontology or an indication that input data will subsequently be provided in the first operational ontology from a specified source if a suitable service is located;
performing a search for a suitable service through a plurality of services accessible to the user device, each accessible service having an associated service description expressed in a corresponding service description ontology and having an associated operational ontology, the searching being carried out by comparing the service description of each accessible service with the service description of the requested service, the comparison step including using, or forming and using, service description ontology mappings where necessary and, in respect of at least the or each, if any, of the accessible service having a service description matching the requested service, determining if its operational ontology is compatible with the first operational ontology and if so, determining that the or each such accessible service having a matching service description and a compatible operational ontology is a suitable service;
invoking the suitable service or one of the suitable services, if at least one has been found, including translating if necessary the input data from the first operational ontology into the operational ontology of the suitable service and sending the, possibly/translated, input data to the suitable service or informing it of from where to obtain the input data; and
translating, if necessary, the output data from the suitable service and presenting the, possibly translated, output data to the user.

2. A method of invoking, from a device connected to a computer network, an electronic service, from amongst a plurality of such services, available from the network, the method comprising:
receiving an electronic signal representative of a request for an electronic service, the service request being expressed in a first ontology;
forming a group of mappings each of which specifies a method for mapping from the first ontology to another ontology;
using the formed group of mappings to compare the received service request with descriptions of services available on the network expressed in the first ontology or any of the ontologies to which a mapping is available from the first ontology in the formed group of mappings;
selecting one of the electronic services available on the network based on the result of the comparison; and
transmitting an electronic signal to invoke the selected service.

3. A method according to claim 2 further comprising comparing the ontology in which the input data is intended to be supplied to an electronic service once located, and in which the resulting output data is to be output by the service, with the operational ontology of the selected service, and if these are different, determining if a mapping is available on the network for mapping between these ontologies and if not, then trying to find a new service to select.

4. A method according to claim 1 further comprising compiling a mapping database of mappings from one ontology to another and building the mapping database according to the following method:
populating the mapping database with a plurality of direct mappings from one ontology to another; and subsequently
upon receiving a service request expressed in a first ontology, generating a first set of mappings which map from said first ontology to a specified target ontology by selecting appropriate mappings from the mapping database;
forming a second set of mappings which map from any of the target ontologies of the mappings in the first set to a specified secondary target ontology which is different from the first ontology and all of the target ontologies of the mappings in the first set, by selecting any such mappings from the mappings database; and
storing in the mappings database an indication of a new mapping from said first ontology to the secondary target ontology corresponding to one of the mappings in the second set, together with a reference to each of the corresponding mappings in the first and second sets required to make the mapping from the first ontology to the secondary target ontology.

5. A method of operating a computer network-comprising:
providing one or more groups of computer programs and associated data so as to provide one or more services to other users of the computer network,
storing in association with each such service a description of the respective service expressed in a respective ontology,
storing in association with each such service an indication of the respective ontology in which its corresponding service description is expressed, and
making both the service description and the indication of the ontology in which it is expressed available for viewing by potential users of each such respective service.

6. A user device for performing a requested service on behalf of a requesting user, the device comprising:
receiving means for receiving a signal representative of a description of the requested service expressed in a first service description ontology together with either input data expressed in a first operational ontology or an indication that input data will subsequently be provided in the first operational ontology from a specified source if a suitable service is located; and
suitably programmed processing means for:
performing a search for a suitable service through a plurality of services accessible to the user device, each accessible service having an associated service description expressed in a corresponding service description ontology and having an associated operational ontology, the searching being carried out by comparing the service description of each accessible service with the service description of the requested service, the comparison step including using, or forming and using, service description ontology mappings where necessary and, in respect of at least the or each, if any, of the accessible service having a service description matching the requested service, determining if its operational ontology is compatible with the first operational ontology and if so, determining that the or each such accessible service having a matching service description and a compatible operational ontology is a suitable service;
invoking the suitable service or one of the suitable services, if at least one has been found, including translating if necessary the input data from the first operational ontology into the operational ontology of the suitable service and sending the, possibly translated, input data to the suitable service or informing it of from where to obtain the input data; and
translating, if necessary, the output data from the suitable service and controlling output means to present the, possibly translated, output data to the user.

7. Apparatus for searching for and invoking an electronic service available from a computer network, the apparatus including:
receiving means for receiving an electronic signal representative of a request for an electronic service, the service request being expressed in a first ontology;
digital processing and storage means for forming a group of mappings each of which specifies a method for mapping from the first ontology to another ontology;
processing means for using the formed group of mappings to compare the received service request with descriptions of services available on the network expressed in the first ontology or any of the ontologies to which a mapping is available from the first ontology in the formed group of mappings;
processing means for selecting one of the electronic services available on the network based on the result of the comparison; and
transmission means for transmitting an electronic signal to invoke the selected service.

8. A computer program or programs arranged such that while it or they are executed on a computer, it or they cause the computer to carry out the method of claim 1.

9. A computer readable carrier medium carrying the computer program or programs of claim 8.
